(19) United States
(12) Patent Application Publication
(10) Pub. No.: US 2023/0220742 A1
(43) Pub. Date: Jul. 13, 2023

(54) SEALING OF WELLS WITH BIOMASS WASTE

(71) Applicant: B B & M Materials, LLC, Casper, WY (US)

(72) Inventors: David L. Briggs, Newburgh, IN (US); Mark Thomas Mersman, Boulder, CO (US); Dawn Boyter, Doyline, LA (US)

(73) Assignee: B B & M Materials, LLC, Casper, WY (US)

(21) Appl. No.: 17/897,895

(22) Filed: Aug. 29, 2022

Related U.S. Application Data
(60) Provisional application No. 63/297,564, filed on Jan. 7, 2022.

(51) Int. Cl. E21B 33/12

(52) U.S. Cl. CPC E21B 33/1208

(57) ABSTRACT

A method for use of biomass waste to seal a well, includes the steps of: locating a well to be sealed, the well having a lower plug and casing; providing biomass waste; introducing the biomass waste into the casing of the well to fill the casing with the biomass waste to a level above the lower plug; and setting an upper plug immediately above the level of biomass waste.

### FIELD

The present disclosure relates to the sealing of wells. More particularly, the disclosure relates to the use of biomass waste as a sealing material to plug wells, particularly oil and gas wells.

### BACKGROUND

There are a large number of inactive oil and gas wells, and other types of wells associated with oil and gas exploration, such as injection wells. Many, if not most, of the wells are abandoned and need to be plugged. For example, there are 14,000 wells on the orphan well list in Kentucky that are being entered into a plugging program funded by the Federal government.

Plugging of oil and gas wells is typically accomplished using cement. This is expensive and it would be preferable to utilize a waste material if possible.

There is also a growing need to find suitable disposal processes for biomass waste generated from grass, municipal waste, manure, sawmills, and the like. Many of the current disposal programs for biomass waste increase carbon emissions or provide very low carbon credits.

Accordingly, there is a need for a more environmentally suitable and more cost-effective method for disposing of biomass waste without increasing carbon emissions while at the same time providing a source for carbon credits for carbon emitting industries.

It is believed that utilization of biomass waste as described herein can advantageously conserve cement, provide a lower cost material for sealing of wells by plugging, and provide carbon credits.

### SUMMARY

The disclosure advantageously provides methods for use of biomass waste to seal wells.

In one aspect, a method of sealing a well according to the disclosure includes the steps of: locating a well to be sealed, the well having a lower plug and casing; providing biomass waste; introducing the biomass waste into the casing of the well to fill the casing with the biomass waste to a level above the lower plug; and setting an upper plug immediately above the level of biomass waste.

### BRIEF DESCRIPTION OF THE DRAWINGS

Further advantages of the disclosure are apparent by reference to the detailed description when considered in conjunction with the figures, which are not to scale so as to more clearly show the details, wherein like reference numbers indicate like elements throughout the several views, and wherein:

FIG. 1 depicts apparatus for use in providing biomass waste into wells according to the disclosure.

FIGS. 2-4 depicts the plugging of a well using biomass waste in accordance with one embodiment of the disclosure.

FIG. 5 depicts the plugging of a well using biomass waste in accordance with another embodiment of the disclosure.

FIG. 6 depicts plugging of a well while pulling casing according to the disclosure.

FIG. 7 depicts plugging of a well having perforated casing and leaving the casing.

FIG. 8 depicts an example well as plugged in accordance with the disclosure.

### DETAILED DESCRIPTION

With reference to the drawings, the disclosure provides structures and methods for plugging wells utilizing biomass waste, and in particular biochar. Retired wells are plugged for safety reasons and also to avoid seepage of hydrocarbons and other materials from the well. The use of biomass waste according to the disclosure may also advantageously provide a source of carbon credits to industry.

Plugging involves filling the well, conventionally with cement. Often the entire depth of the well is plugged. In other instances, a barrier or plug is set at an intermediate point of the well and the well is filled from that point to the surface.

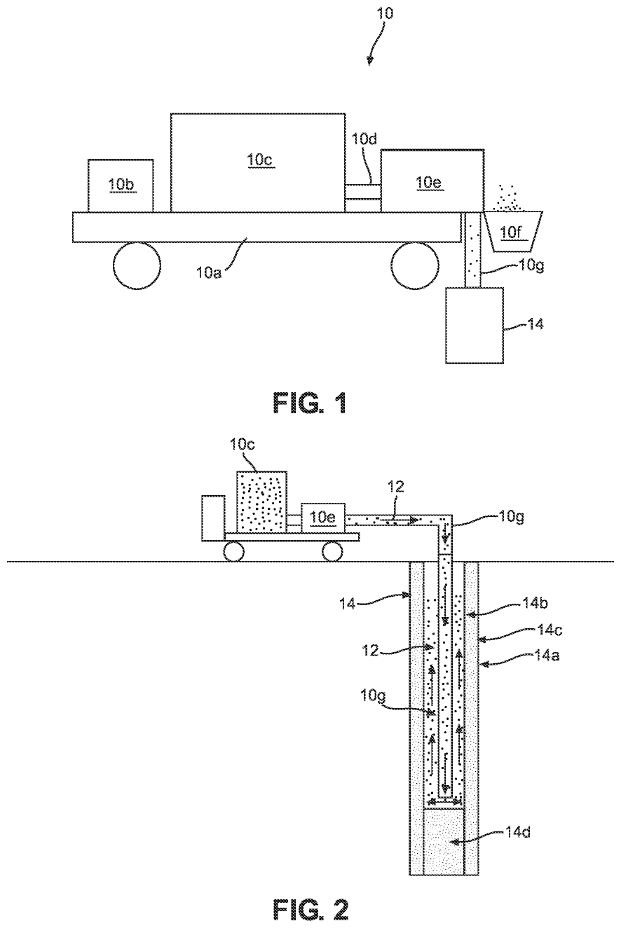

Within initial reference to FIG. 1, there is shown apparatus 10 for use in the plugging of wells according to the disclosure. The apparatus 10 as shown is in the form of a pump truck configured to mix and pump a biomass waste slurry 12 into a well 14 for capping and/or plugging of the well 14. In this case, the apparatus 10 is positioned adjacent the well 14. The apparatus 10 may also mix and pump cement in the event cement is also utilized in the plugging of the well. As described herein, when cement is used, the cement preferably includes some of the biomass waste as a component of the cement.

The apparatus 10 configured as a pump truck has a wheeled or tracked motorized vehicle frame 10a operated from a cab 10b. A blending tank 10c is desirably provided on the frame 10a or is positioned closely adjacent the frame 10a. The blending tank 10c is in fluid communication via piping 10d with a displacement pump 10e desirably located on the frame 10a and receiving power from a motor associated with the motorized frame 10a. The piping 10d provides a recirculating loop between the tank 10c and the pump 10e. The apparatus 10 also includes a hopper 10f located to accommodate introduction of biomass waste to the apparatus 10. The hopper 10f may also be used to introduce cement. A variable length outlet pipe 10g is used to introduce the biomass waste 12 (or cement) from the apparatus 10 into the well 14.

The blending tank 10c and the displacement pump 10e are configured to recirculate and blend the biomass waste with liquid and pump it into the well 14 to provide the biomass slurry 12. The blending tank 10c and the displacement pump 10e are also suitably configured to blend cement with water and pump it into the well 14.

For the purposes of the disclosure, “biomass waste” is or includes an organic material that is derived from living organisms such as plants or animals. Biomass waste can be or include, for example, agricultural waste (e.g., corn stover), forestry residue (e.g., branches, leaves, etc.), woody biomass (e.g., trees, shrubs, bushes, etc.), non-woody biomass (e.g., sugar cane, cereal straw, seaweed, algae, cotton, grass, kelp, soil, etc.), and/or processed waste (e.g., cereal husks and cobs, bagasse, nut shells, plant oil cake, sawmill waste, food waste, human waste, animal waste, animal fats, etc.).

In various examples, a “carbon-containing material” can be or include a solid, liquid, or gas having one or more carbon atoms. Some carbon-containing materials can be referred to herein as being “biogenic.” Such biogenic carbon-containing materials can be produced directly by living organisms (e.g., biomass such as wood, grass, or animal fat) or can be derived from materials produced by the living organisms (e.g., biochar, biocrude, glycerol, or gasoline), as described herein.

The biomass waste can be converted into biochar by feeding the biomass waste into any type of pyrolyzing system ranging from a flash pyrolyzer, which operates on a sub-second basis to roasting techniques that require several hours. The pyrolysis process can be oxygen or air fed and, thus, rely on partial oxidation for heating, or it can be indirectly heated and operate in inert or reducing atmospheres to minimize partial oxidation products. The pyrolyzer can operate in a vacuum, at atmospheric pressure, or at high pressure. It can operate with a gaseous, liquid, or supercritical fluid working medium. In most cases, the carbon output from such pyrolysis operations includes two or more components, typically including the following: (A) biochar which is small aggregates of carbon which partially retain some of the cellular structure of the original biomaterial and (B) micro to nanoscale filtrate carbon from the pyrolyzer's gas or liquid working.

Ideally, for the purposes of this disclosure the biomass waste, such as biochar, should be in the form of pellets having a density of about 0.56 grams per cm³ and have a low moisture content such as a moisture content of less than 15 wt. %, for example 10 wt. % or less. It is preferred that the biomass waste have a high carbon content, such as a carbon content of 70 or 80 wt. % based on a total weight of the biomass waste material.

The biomass waste is blended with a liquid by the apparatus 10 to provide the biowaste slurry 12. The liquid is desirably water with additives such as polymer treated bentonite clay and/or polymeric gels. The polymer treated bentonite clay is desirably added for wells located in jurisdictions having weight requirements for well fluids. For example, Indiana, Illinois and Kentucky do not have a weight requirement for well spacer fluid, however, Louisiana has a minimum requirement of 9.0 lb./gal. If such weight requirements are not present, other suitable polymeric materials may be used such as synthetic polymers (e.g., hydrolyzed polyacrylamide), biopolymers (e.g., xanthan), and, associative polymers.

The polymerized bentonite clay and/or polymeric gels advantageously serve to increase the viscosity of the water and act as mobility control agents to entrain the biomass waste in the biomass slurry 12 to maintain the biomass waste in suspension and inhibit the biomass waste from settling out of the fluid and sticking to the outlet pipe 10g once introduced into the well 14.

The blending tank 10c is desirably configured to provide visibility of the characteristics of the slurry 12 being prepared. For the purpose of example, a polymerized bentonite clay was mixed by jetting action in approximately 25 barrels of fresh water at approximately 30 Marsh funnel viscosity. One bag of biomass waste in the form of biochar was added. The surface of the water was observed to have a skim of oil that was absorbed by the biochar and the excess oil tracked with the oil contaminated biochar while being stirred with a jetting hose. The viscosity of the slurry by adding another bag of polymerized bentonite clay, after which the viscosity of the slurry was observed to be 70 to 80 funnel viscosity. Additional biochar was added until a total blending and suspension of the biochar was observed.

With reference to FIGS. 2-4, there is shown one method for plugging of the well 14 using the biomass waste 12. The well 14 utilized in this disclosure for illustrating the disclosure is described in terms of basic well construction associated with the production of oil and gas. This can include other types of wells, including class II injection wells which are used to inject fluids associated with oil and natural gas production. Class II fluids are primarily brines (salt water) that are brought to the surface while producing oil and gas. Depending upon applicable regulations and the like, it will be appreciated that the methodologies and structures described herein may be applicable for use with a variety of well types.

Oil and gas wells corresponding to the well 14 are provided by drilling a borehole 14a into the earth. If oil and/or gas are located in producible amounts, the well is cased and completed for production of the oil and/or gas. Wells may have various levels of casing or steel pipe, such as surface casing and production casing interior of the surface casing. Depending on well depth, there may be various stages of casing of decreasing diameter, with the longest and most interior casing having the smallest diameter and referred to as production or long string casing 14b, which is set using cement 14c. The bottom of the well 14 typically includes a cement plug 14d. A similar well structure is used with Class II injection wells. As will be observed, the well 14 of FIG. 2 is shown having the casing cement 14c extending the entire depth of the well, from the bottom to the surface.

As seen in FIG. 2, to introduce the slurry 12 into the well 14 the outlet pipe 10g is extended into the well and the slurry of biomass waste 12 is pumped into the well 14. The pump 10e is operated to circulate the slurry 12 up the annulus between the outlet pipe 10g and casing to the next cement plug depth. This could be the top of the well 14, or an intermediate lower location in the well. If an intermediate location, a cement plug is set and then the slurry of biomass waste 12 is loaded over the set plug. For example, in deep wells there may be several intermediate plugs set, with the slurry of biomass waste 12 filling the space between the plugs.

Pumping of the slurry 12 into the well 14 as shown is done by a balance method where the outlet pipe 10g is positioned immediately above the bottom cement plug 14d until the well 14 is full. The viscosity of the slurry 12 is desirably to be sufficient to carry the biomass waste through the pumping action and for the biomass waste to remain in suspension after pumping is complete to avoid settling around the outlet pipe 10g causing the outlet pipe 16 to become stuck in the well 14. Once introduction of the slurry 12 into the well 14 is completed, an upper cement plug 14e is set.

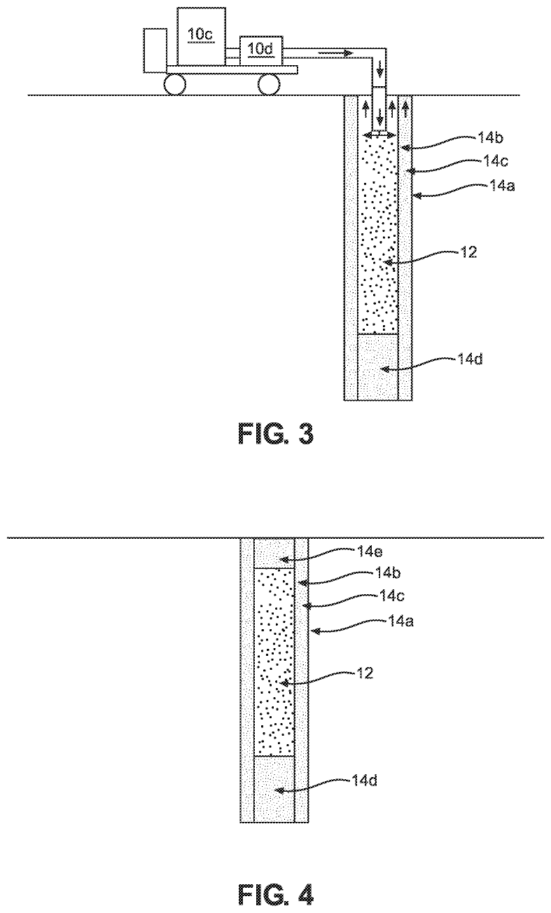

FIGS. 3 and 4 depict use of the apparatus 10 to blend and pump cement to set the upper cement plug 14e. As described above, biomass waste is desirably incorporated into the cement used to provide the plug 14e. Further, once the well 14 is plugged, biomass waste may be used at the surface and incorporated into the soil to remediate the well site.

As will be appreciated, the well 14 having the plugs 14d and 14e, with the slurry of biomass waste 12 therebetween effectively plugs the well 14 in a manner that also serves to dispose of biomass waste without increasing carbon emissions while at the same time providing a source for carbon credits for carbon emitting industries. Further, the plugged well structure provides a utilization of biomass waste that advantageously conserves cement and provides a lower cost material for the sealing of wells.

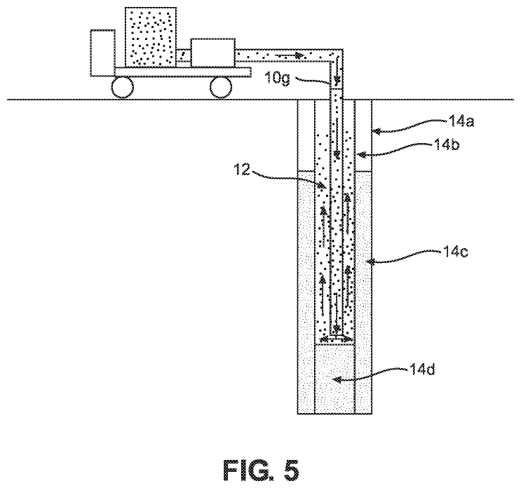

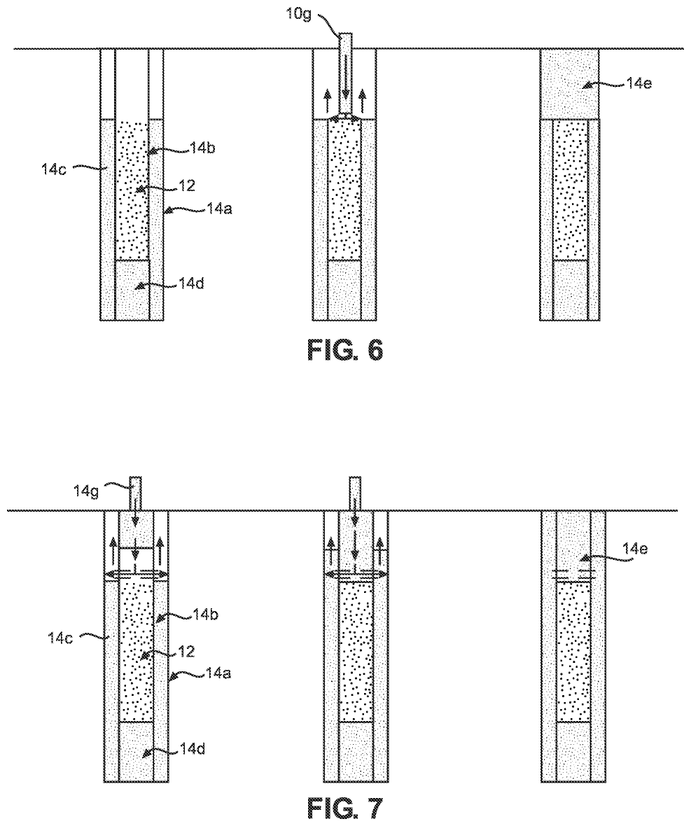

With reference to FIG. 5, there is shown the methodology of the disclosure applied to a well in which the long string casing 14b is not cemented all the way to the surface. In this circumstance, the slurry 12 is desirably applied to the interior annulus of the casing 14b up to the depth that the casing cement 14c ends. Next, FIGS. 6 and 7 show two different methods according to the disclosure for finishing the plugging operation by setting of the upper cement plug 14e.

As shown in FIG. 6, setting of the upper cement plug 14e involves cutting off of the uncemented upper portion of the casing 14b and removing it from the well 14. Following this, the upper plug 14e is installed.

FIG. 7 shows another method for setting of the upper cement plug 14e when the upper portion of the casing 14b is not cemented. As shown, perforations 14h are formed in a lower portion of the uncemented casing 14b, with the casing remaining in the well 14. Cement is pumped down the casing and out the perforations 14h. The cement is circulated to the surface and the center of the upper portion of the casing 14b will remain full to provide the upper plug 14e.

Another method according to the disclosure is provided in which biomass waste, not in slurry form, but dry, is introduced into the casing of the well 14 onto the lower plug 14d and mechanically packed. The amount of the biomass waste is selected to reach to the level of the upper plug 14e. The upper plug 14e is then installed in a manner as previously described to complete the plugging of the well.

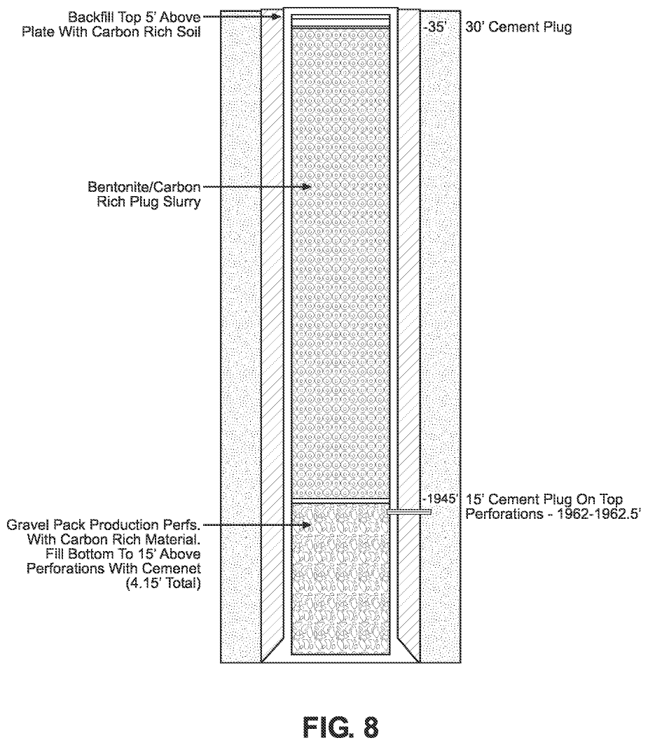

For the purpose of example, a slurry made with biomass waste according to the disclosure was utilized in to seal an Example Well in Louisiana. The Example Well is shown in FIG. 8.

For this Example Well, a lesser amount of biomass waste (biochar) was conservatively utilized, it being appreciated that it is desirable to utilize more biomass waste or biochar for environmental and economy reasons. In this case, 2 bags of biochar were utilized in the gravel pack, and 19 bags in a 25-barrel slurry and 3 bags in the fill dirt and around the well. A bag is 16 lbs. of biochar.

The foregoing description of preferred embodiments for this disclosure has been presented for purposes of illustration and description. It is not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated.

1. A method for use of biomass waste to seal a well, includes the steps of:
locating a well to be sealed, the well having a lower plug and casing;
providing biomass waste;
introducing the biomass waste into the casing of the well to fill the casing with the biomass waste to a level above the lower plug; and
setting an upper plug immediately above the level of biomass waste.

2. The method of claim 1, wherein the step of providing biomass waste includes mechanically packing the biomass waste into the well.

3. The method of claim 1, wherein the step of providing biomass waste includes providing a slurry of biomass waste.

4. The method of claim 1, wherein the step of introducing the biomass waste involves pumping the slurry of biomass waste.

5. The method of claim 1, wherein the biomass waste is blended with a liquid to provide the slurry, with the slurry including additives such as polymer treated bentonite clay and/or polymeric gels to entrain the biomass waste in the slurry to maintain the biomass waste in suspension.
